(19) United States
(12) Patent Application Publication
(10) Pub. No.: US 2005/0155935 A1
(43) Pub. Date: Jul. 21, 2005

(54) Liquid filtration device

(75) Inventor: Tei-Fu Chen, Torrance, CA (US)

Correspondence Address: c/o LADAS & PARRY;Mavis S. Gallenson, Esq., Suite 2100, 5670 Wilshire Boulevard, Los Angeles, CA, 90036-5679, US

(73) Assignee: Sunrider Corporation dba Sunrider International

(21) Appl. No.: 10/760,038

(22) Filed: Jan. 15, 2004

(51) Int. Cl. B03C 1/00

(52) U.S. Cl. 210/748

(57) ABSTRACT

A device for purifying a liquid stream comprises a filter for passing a liquid stream therethrough to remove impurities therefrom, and a radiation source disposed to radiate the liquid stream. Optionally, an oxygenation device in fluid communication with the radiation device may be provided to mix oxygen into the liquid.

### TECHNICAL FIELD

This disclosure relates to liquid filtration processes and devices, and methods of use thereof.

### BACKGROUND

There has always existed a need for purifying various liquids to different purity levels. A common need is to purify water for drinking, cooking, bathing, cleaning, industrial processes, and other purposes. Water filtration devices have been known for many years, and they produce water purified to varying degrees. However, the majority of available water filtration devices do not produce highly purified water in a simple and also economical manner. Available devices also do not produce highly purified and oxygenated water.

What is therefore still needed are methods and devices for purifying liquids in a simple to use and economical manner that is preferably easily adaptable for use in the common household environment. The embodiments of the present disclosure answer these and other needs.

### SUMMARY

In a first embodiment disclosed herein, a device for purifying a liquid stream comprises a filter for passing a liquid stream therethrough to remove impurities therefrom, and a radiation source disposed to radiate the liquid stream.

In other embodiments disclosed herein, the radiation source may be located upstream or downstream of the filter. The radiation source may emit ultraviolet radiation, and may comprise an ultraviolet lamp. The filter may comprise an inner filter to pass the liquid stream therethrough, and an outer filter surrounding the inner filter to pass the liquid stream therethrough and in fluid communication with the inner filter. The filter may comprise one or more filters selected from the group comprised of fiber filters, stone filters, carbon filters, polymer filters, and porcelain filters.

In other embodiments, the device may further comprise an oxygenation device in fluid communication with the radiation device to mix oxygen into the liquid. The oxygenation device may comprise one or more molecular sieves to extract the oxygen from air by pressure swing adsorption.

In another embodiment disclosed herein, a method for purifying a liquid stream comprises passing a liquid stream through a filter to remove impurities therefrom, and exposing the liquid stream to a radiation source to radiate the liquid stream.

These and other features and advantages will become further apparent from the detailed description and accompanying figures that follow. In the figures and description, numerals indicate the various features, like numerals referring to like features throughout both the drawings and the description.

### BRIEF DESCRIPTION OF THE DRAWINGS

FIG. 1 is a front view of a liquid filtration device as disclosed herein;

FIG. 1a is a sectional view taken along line A-A of the filtration device of FIG. 1;

FIG. 2 is a front view of a diverter as disclosed herein that may be used in connection with the liquid filtration device of FIG. 1;

FIG. 3a is a sectional view of a filter taken along line B-B of the filtration device of FIG. 1;

FIG. 3b is a cross-sectional perspective view of the outer core of the filter of FIG. 3a;

FIG. 3c is a top plan view of the internal section of the filter outer core of FIG. 3b;

FIG. 4 is a sectional view of an ultraviolet radiation filtration device taken along line B-B of FIG. 1; and

FIG. 5 is a sectional view of an oxygenation device along taken line B-B of FIG. 1.

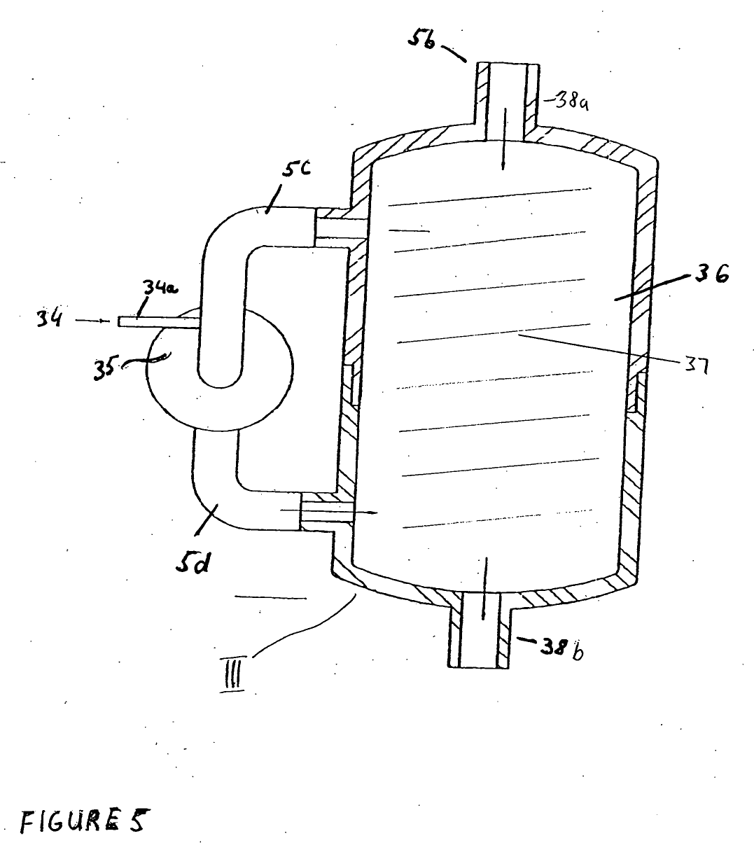

### DETAILED DESCRIPTION

The needs previously mentioned are answered herein with liquid purification devices and methods that include filtering the liquid with a filter device to remove impurities therefrom, and also radiating the liquid. Optionally, oxygen may be mixed with the liquid in an oxygenation device.

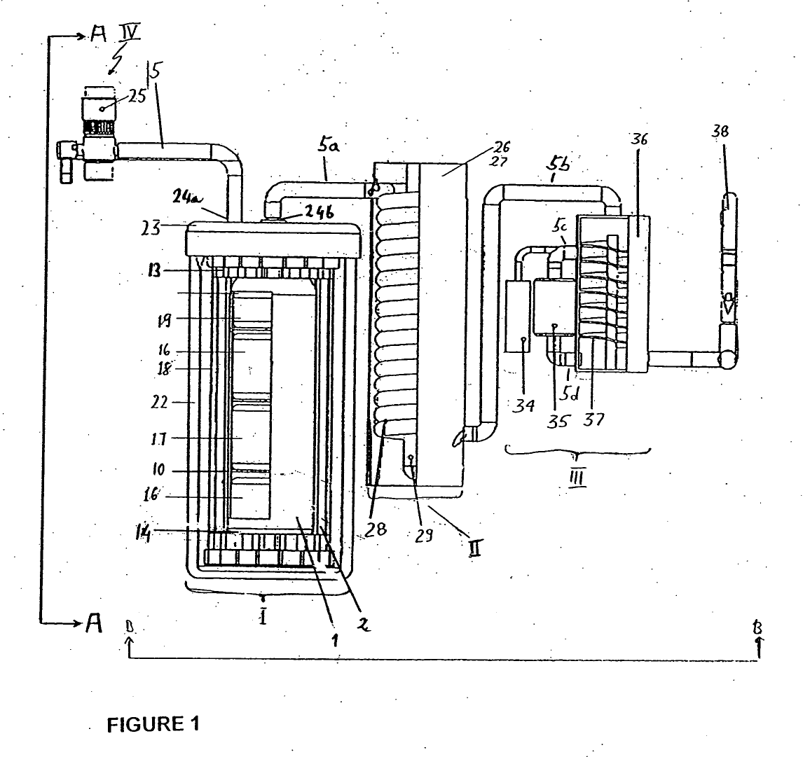

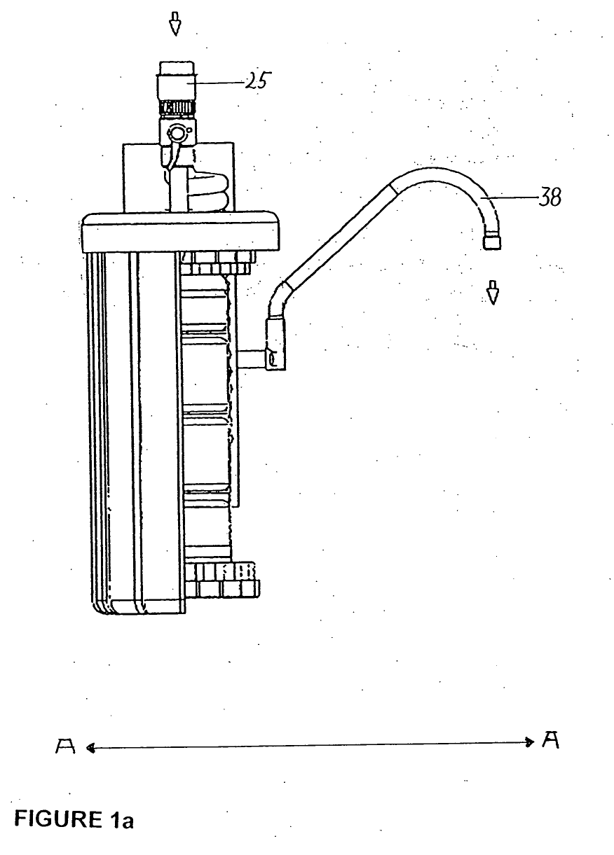

Referring to FIG. 1, in one embodiment a liquid filtration device as disclosed herein is adapted to filter a stream of water emanating from a water tap. The filtration device includes, generally, a filter I, a radiation source II, an oxygenation device III, and a connector IV for connecting to the water source.

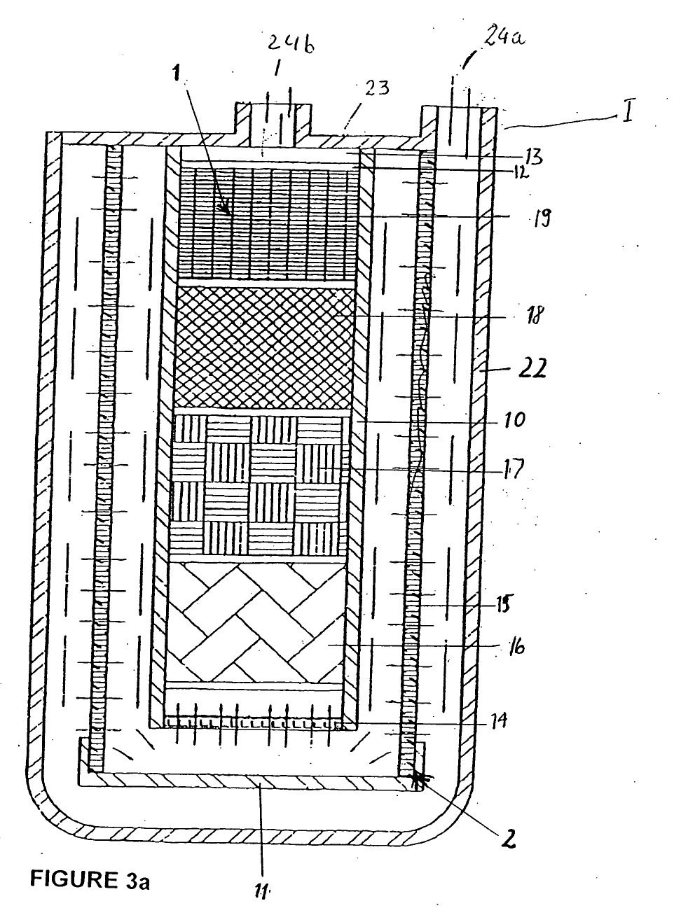

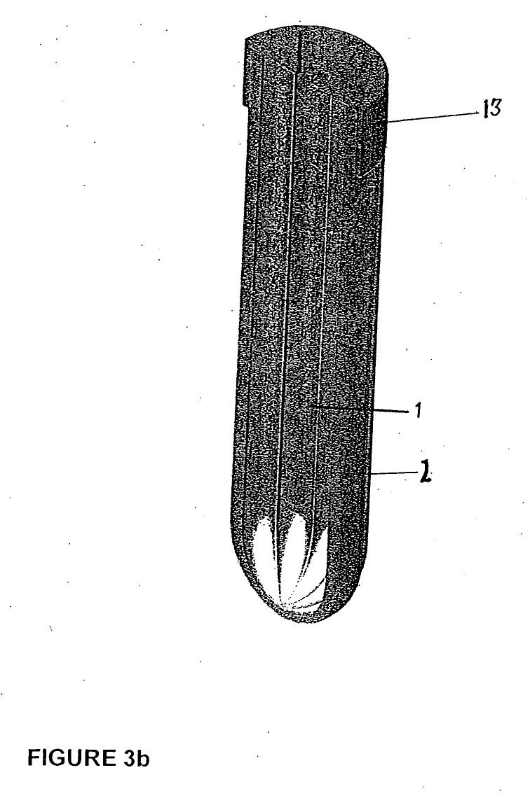

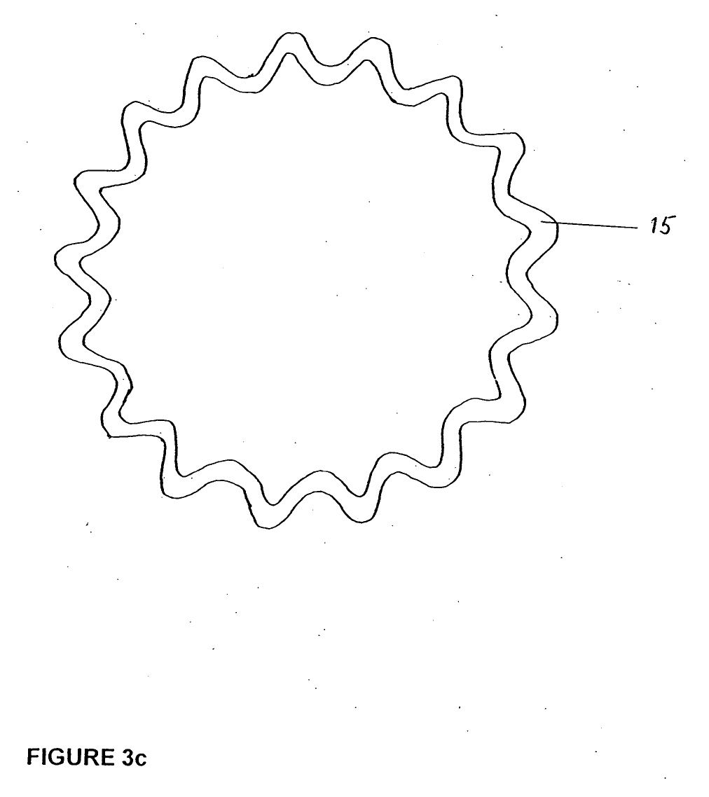

With further reference to FIG. 3a, the filter I of this embodiment is formed as a double layer filtration device including an inner filter 1 and an outer filter 2. The inner filter 1 includes an inner filter bottom 14, a top lid 13, and an inner upper filter 12 therebetween. The inner filter is further surrounded by a center tube 10. In one embodiment, the inner filter 1 may include a plurality of filter layers, such as the four filter layers of the embodiment of FIG. 3a: a porcelain filter 16, a stone filter 17, a fiber filter 18, and an activated carbon filter 19. The filter layers are disposed within the central tube 10 between the inner filter bottom 14 and the inner upper filter 12.

With reference to FIGS. 3a and 3b, the inner filter 1 is surrounded by the outer filter 2. The outer filter 2 includes an outer filter tube 15 disposed on a base stand 11. The inner filter 1 and the outer filter 2 are housed in an outer body 22 that includes a filter top lid 23. The filter top lid 23 is formed with an inlet 24a and an outlet 24b. Referring to FIG. 3c, the outer filter tube 15 is formed with an empty center, and may be formed with a wall surface that is undulating or serrated so that the contact surface area of the filter 15 is increased.

In use, the liquid to be purified (e.g. water) enters the double layered filtration device I through the inlet 24a from the filter top lid 23 and flows downwardly between the outer body 22 and the outer filter tube 15 of the outer filter 2. The liquid passes through the vertical walls of the outer filter tube 15 in a horizontal direction where it undergoes the first filtration stage. After passing through the vertical walls of the outer filter tube 15, the liquid enters the inner filter 1 through the porous inner filter bottom lid 14 and flows through the four layers of filters (16, 17, 18, and 19) from the bottom to the top of the inner filter 1. The liquid then leaves the inner filter 1 through the porous inner upper filter 12 and subsequently through the porous inner filter top lid 13, thereby exiting the second filtration stage. The liquid finally leaves the double layered filtration device I through the outlet 24b formed in the filter top lid 23. A filter such as double layered filtration device I increases the amount of filtration in a set period of time significantly and saves space as two separate stages of filtration may be disposed within the same volume.

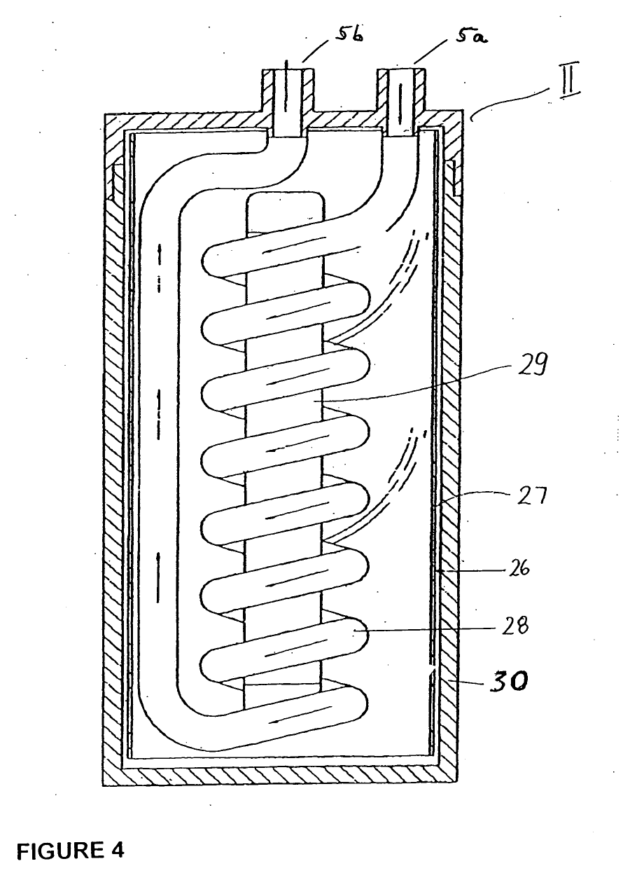

With continued reference to FIG. 1 and further reference to FIG. 4a, the liquid exiting the outlet 24b is then transferred through line 5a to radiation source II. In the embodiment shown, radiation source II is an ultraviolet lamp that includes a cylindrical casing 30 and a set of highly reflecting mirrors disposed the vertical walls within the cylindrical casing 30. The mirrors include reflective metal plates 26 and reflective films 27 disposed thereon. A spiral tube 28 is disposed within the cylindrical casing 30 to extend between the openings of the lines 5a and 5b. An ultraviolet lamp 29 extends through and is surrounded by the coils of the spiral tube 28. The mirrors are disposed so as to effectively reflect sterilizing rays emitted from the ultraviolet lamp 29.

In use, the liquid enters the spiral tube 28 from the top through the line 5a and flows downward around the ultraviolet lamp 29 in the spiral tube 28 and leaves the radiation source II through the line 5b. In this embodiment, the liquid is continuously exposed to ultraviolet rays through the reflecting mirrors as it passes through the coiled spiral tube 28 that is wrapped around the lamp 29. This is very effective and allows the purification of the water by a highly efficient sterilizing process.

With continued reference to FIG. 1 and further reference to FIG. 4a, in the embodiment shown the liquid exiting the radiation source II is transferred through liquid line 5b to an oxygenation device III for oxygenation of the liquid. The oxygenation device III includes a cylindrical tank 36 that is filled with liquid and is employed for dissolving oxygen. The oxygen-dissolving tank 36 contains liquid circulating plates 37 disposed horizontally within the tank, and is formed with a liquid entrance 38a at the top for connecting to liquid line 5b and a liquid exit 38b at the bottom for exiting the oxidized liquid into liquid line 38. An upper liquid line 5c is attached to the vertical wall in the upper region of the tank 36 and a lower liquid line 5d is attached to the vertical wall in the lower region of the tank. The upper liquid line 5c leads to an external pump 35, and a horizontal airflow tube 34a is attached to the upper liquid line above the pump 35 shortly before the upper liquid line reaches the pump. An oxygen generator 34 is connected to the upper liquid line 5c via the airflow tube 34a, which supplies oxygen from the oxygen generator 34 to the upper liquid line 5c. The lower liquid line 5d is attached below the pump 35 on the opposite side to the attachment site of the upper liquid line 5c.

In use, the liquid exits the oxygen-dissolving tank 36 through the upper liquid line 5c and the oxygen enters the upper liquid line via horizontal airflow tube 34a. An anti-backflow valve device (not shown in the drawing) may be installed inside the airflow tube 34a. Air is drawn by capillary action from airflow tube 34a and the liquid is mixed with the oxygen inside the upper-liquid line 5c. The upper liquid line 5c passes the liquid mixed with oxygen to the pump 35, which acts to increase the pressure of the oxygenated liquid. The oxygenated liquid exits the pump 35 into the lower liquid line 5d which leads it into the lower region of the oxygen-dissolving tank 36.

The oxygenation process disclosed is preferably a continuous process. Sterilized liquid supplied by the radiation source II enters the oxygen-dissolving tank 36 at the top through the entrance 38a. The sterilized liquid then enters a circulation cycle that leaves the tank 36 through upper liquid line 5c where it is mixed with oxygen from the airflow tube 34a. The liquid and oxygen mixture is pumped by the pump 35 and introduced at increased pressure into the lower portion of the tank 36 via lower liquid line 5d. Sterilized oxygenated liquid finally leaves the oxygenation device III through liquid exit 38b.

The oxygen generator 34 extracts oxygen from atmospheric air via known methods such as, inter alia, pressure swing adsorption (PSA). As known to those skilled in the art, PSA typically employs a column filled with zeolite molecular sieves that differentially adsorb certain gases. As air flows through a column (or bed) of such molecular sieves, the component gases it contains are adsorbed and stratified in the order of their relative affinity to the molecular sieve material. This process may be continued until the penultimate gas component stratifies near the end of the column. When the full column length has been used, the column must be regenerated by desorbing (or purging) the adsorbed gases. Purging is accomplished by reducing the pressure in the column and back-flushing with some of the concentrated gas product. Adsorption and desorption are completely reversible processes and can be carried out indefinitely. If properly cycled through the adsorb-desorb process, molecular sieve column do not wear out or become clogged.

In an embodiment, the oxygenation device III may employ an Advanced Technology Fractionator (ATF) for extracting oxygen from air. As known, an ATF concentrator provides (i) a rotary distribution valve that employs a face seal and is driven at low speed by a small motor similar to those found in electric clocks; (ii) multiple (e.g. twelve) molecular sieve beds (columns) with length-to-diameter ratios much greater than those of conventional oxygen concentrators; and (iii) large-scale integration of all components by integral manifolding and sealing, eliminating all but two hose connections.

The rotary distribution valve built into the ATF directs the flow of compressed air to a group of four molecular sieve beds at any given moment. At the same time, another four beds are allowed to purge to atmosphere through the valve. The remaining four beds are interconnected through the valve to equalize pressure as they transition between adsorbing and desorbing. The combined twelve sieve beds of the ATF device contain about the same amount of molecular sieve as a conventional two-bed oxygen concentrator.

Variations in compressor pressure experienced when employing an ATF are typically much lower than those exhibited by conventional concentrators, and the oxygen product pressure in an ATF system is essentially constant. Furthermore, the ATF is simple, compact, and eliminates up to 60 pneumatic connections and 30 electrical connections found in conventional concentrators. The compact, lightweight design of the ATF allows reduction of size and mass of the complete concentrator.

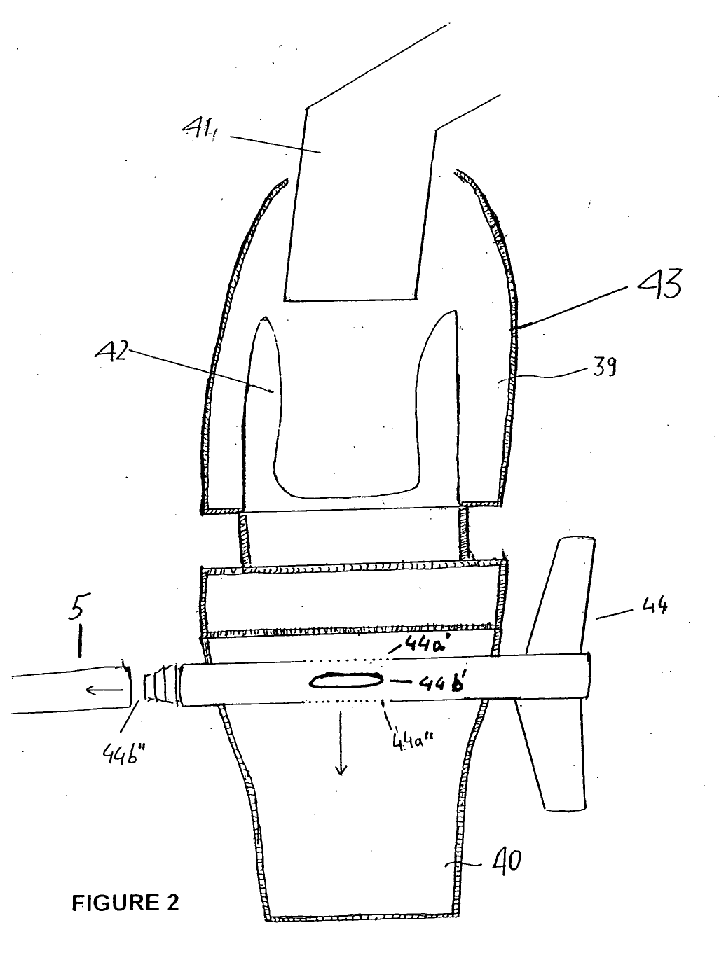

With reference now to FIG. 2, in a further embodiment disclosed herein, a connector IV is provided that may be easily attached to a liquid source such as a typical water faucet 41. The connector IV includes an upper level connector 39 and a lower diverter 40. The upper connector 39 contains a rubber sleeve 42 for fitting onto the water faucet 41, and a high elastic shrink-wrapping film 43 that will wrap tightly to the water faucet 41 upon application of heat thereto, thereby allowing the connector IV to be firmly attached to any water faucet 41. The lower diverter 40 of the connector IV contains a valve 44 formed with generally opposed, cooperating openings 44a′, 44a″ and also formed with opening 44b′. The valve 44 may be rotated about its axis into an orientation such that the opening 44a′ is located at the top and the opening 44a″ is located at the bottom of the valve. In this orientation, the water exiting the faucet 41 flows through the connector IV downward to exit at the bottom of the connector. The valve 44 may also be rotated about its axis into a different orientation such that the opening 44b′ is located at the top of the valve. In this orientation the water exiting the faucet 41 flows through the opening 44b′ into the tube of the switching valve 44 and then through out the opening 44b″ into the line 5 of the filtration device described elsewhere herein. Thus, in this orientation of the valve 44, water may flow freely from the faucet 41 through the connector IV and into the first filtration process stage I as described elsewhere herein with reference to FIGS. 1 and 3a-3c.

Table 1 shows a list of parts that may be selected by those skilled in the art to practice the embodiments disclosed herein.

Having now described the invention in accordance with the requirements of the patent statutes, those skilled in this art will understand how to make changes and modifications to the present invention to meet their specific requirements or conditions. Such changes and modifications may be made without departing from the scope and spirit of the invention as disclosed herein.

TABLE 1

| Reference | | | Material of |
|---|---|---|---|
| number | Part identifier | Dimension | construction |
| 5 | Soft tube | ¾″ | |
| 15 | Porcelain | 72*100*250* | |
| | filter | | |
| 11 | Base stand | 250 g | |
| 12 | Upper filter | 280 g | |
| 13 | Inner Filter | 70 g | |
| | Top Lid | | |
| 14 | Inner Filter | 70 g | |
| | Bottom Lid | | |
| 10 | Center Tube | 190 × 52 mm | |
| 16 | Fiber Filter | 65 × 61 mm | |
| 17 | Stone Filter | 6.5 mm | |
| 18 | Activated | 16 × 40 | |
| | Carbon | | |
| 19 | Porcelain | 3.5 mm | |
| | Filter | | |
| 20 | Large O-Ring | 100 × 3/mm | Rubber |
| 21 | Small O-Ring | 19 × 3/mm | Rubber |
| 24 | Clip | | Stainless |
| | | | Steel |
| 25 | Water Inlet | 3/4″ × 40 mm × 1100 mm | Copper/Silver |
| | Valve | | |
| 26 | Reflective | | Aluminum |
| | Metal Plate | | |
| 27 | Reflective | | Film |
| | Sheet | | |
| 28 | Spiral Tube | 9 × 12.5 mm × 3.62 m | |
| 33 | Electrical Wire | 2.5 m | |
| 34 | Oxygen | 1 kg | Oxygen Filter |
| | Generator | | |
| 38 | Water Outlet | | Copper/Silver |
| 43 | Wrapping Film | | Elastic Shrink |

1. A device for purifying a liquid stream, comprising:
a filter for passing a liquid stream therethrough to remove impurities therefrom; and
a radiation source disposed to radiate the liquid stream.

2. The device of claim 1, wherein the radiation source is located upstream of the filter.

3. The device of claim 1, wherein the radiation source is located downstream of the filter.

4. The device of claim 1, wherein the radiation source emits ultraviolet radiation.

5. The device of claim 4, wherein the radiation source comprises:
an ultraviolet lamp.

6. The device of claim 5, wherein the radiation source further comprises:
a reflector disposed to reflect the radiation passing through the fluid stream back into the fluid.

7. The device of claim 6, wherein the radiation source further comprises:
a spiral tube located to pass the fluid stream therethrough and between the ultraviolet lamp and the reflector.

8. The device of claim 7, wherein the spiral tube is arranged to surround the ultraviolet lamp and the reflector is arranged to surround the spiral tube.

9. The device of claim 1, wherein the filter comprises:
an inner filter to pass the liquid stream therethrough; and
an outer filter surrounding the inner filter to pass the liquid stream therethrough and in fluid communication with the inner filter.

10. The device of claim 9, wherein the inner filter comprises:
one or more filters selected from the group comprised of fiber filters, stone filters, carbon filters, and porcelain filters.

11. The device of claim 9, wherein the double filter is formed with an outer layer comprising:
one or more filters selected from the group of materials comprised of porcelain, activated carbon, and polymers.

12. The device of claim 1, wherein the filter comprises:
one or more filters selected from the group comprised of fiber filters, stone filters, carbon filters, polymer filters, and porcelain filters.

13. The device of claim 1, further comprising:
an oxygenation device in fluid communication with the radiation device to mix oxygen into the liquid.

14. The device of claim 13, wherein the oxygenation device comprises:
one or more molecular sieves to extract the oxygen from air by pressure swing adsorption.

15. A method for purifying a liquid stream, comprising:
passing a liquid stream through a filter to remove impurities therefrom; and
exposing the liquid stream to a radiation source to radiate the liquid stream.

16. The method of claim 15, wherein the liquid stream is exposed to the radiation source after passing through the filter.

17. The method of claim 15, wherein the liquid stream is exposed to the radiation source before passing through the filter.

18. The method of claim 15, wherein the radiation source emits ultraviolet radiation.

19. The method of claim 18, wherein the radiation source comprises:
an ultraviolet lamp.

20. The method of claim 19, wherein the radiation source further comprises:
a reflector disposed to reflect the radiation passing through the fluid stream back into the fluid.

21. The method of claim 20, wherein the radiation source further comprises:
a spiral tube located to pass the fluid stream therethrough and between the ultraviolet lamp and the reflector.

22. The method of claim 21, wherein the spiral tube is arranged to surround the ultraviolet lamp and the reflector is arranged to surround the spiral tube.

23. The method of claim 15, wherein the filter comprises:
an inner filter to pass the liquid stream therethrough; and
an outer filter surrounding the inner filter to pass the liquid stream therethrough and in fluid communication with the inner filter.

24. The method of claim 23, wherein the inner filter comprises:
one or more filters selected from the group comprised of fiber filters, stone filters, carbon filters, and porcelain filters.

25. The method of claim 23, wherein the double filter is formed with an outer layer comprising:
one or more filters selected from the group of materials comprised of porcelain, activated carbon, and polymers.

26. The method of claim 15, wherein the filter comprises:
one or more filters selected from the group comprised of fiber filters, stone filters, carbon filters, polymer filters, and porcelain filters.

27. The method of claim 15, further comprising:
passing the fluid stream through an oxygenation device to mix oxygen into the liquid.

28. The method of claim 27, further comprising:
passing air through one or more molecular sieves to extract the oxygen from the air by pressure swing adsorption.
